(19) United States
(12) Patent Application Publication
(10) Pub. No.: US 2026/0339633 A1
(43) Pub. Date: Oct. 29, 2026

(54) NON-TRANSITORY COMPUTER READABLE STORAGE MEDIUM STORING A COMPILER PROGRAM, A COMPILATION METHOD, AND AN EXECUTION MACHINE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventors: Atsushi NARISHIGE, Nisshin-shi (JP); Sakon YAMAMOTO, Nisshin-shi (JP)

(21) Appl. No.: 19/546,994

(22) Filed: Feb. 23, 2026

(30) Foreign Application Priority Data
Apr. 23, 2025 (JP) 2025-071105

(51) Int. Cl. G06F 8/41

(52) U.S. Cl. CPC G06F 8/445

(57) ABSTRACT

A compilation method includes determining having a multi-core processor perform a single-core processing for at least one of: (i) a first process of calculating probability; or (ii) a second process including a branch node, a merge node, and at least one of a tensor transpose node or an inner product calculation node between the branch node and the merge node, determining having the multi-core processor perform a multiple-core processing for a process other than the first process and the second process, and converting a source code into an object code according to a result of the determining.

### CROSS REFERENCE TO RELATED APPLICATION

The present application claims the benefit of priority from Japanese Patent Application No. 2025-071105 filed on Apr. 23, 2025. The entire disclosure of the above application is incorporated herein by reference.

### TECHNICAL FIELD

The present disclosure relates to a technology for performing compilation for a multi-core processor.

### BACKGROUND ART

In deep learning neural networks (DNN), typified by transformers, the computational load and number of parameters are large, resulting in lengthy processing times.

### SUMMARY

A non-transitory computer readable storage medium storing a compiler program is provided. The compiler program, when executed by at least one processor, may cause the at least one processor to perform: determining whether to have a multi-core processor including multiple cores perform multi-core processing or single-core processing; and converting a source code into an object code that is executable by the multi-core processor according to a result of the determining. The determining of whether to have the multi-core processor perform the multi-core processing or the single-core processing may include determining the single-core processing as at least one of, in the source code: (i) a first process of performing probability calculation; or (ii) a second process including a branch node at which a process is branched into sub-processes, a merge node at which the sub-processes merge, and at least one of a tensor transpose node or an inner product calculation node between the branch node and the merge node. The tensor transpose node is configured to transpose a tensor, and the inner product calculation node is configured to perform inner product calculation.

### BRIEF DESCRIPTION OF DRAWINGS

FIG. 1 is a schematic configuration diagram of a processing system including a compiler and an execution machine according to an embodiment.

FIG. 2 is a flowchart illustrating a compilation processing routine.

FIG. 3 is a flowchart showing a part of a AT part specifying processing routine.

FIG. 4 is an explanatory diagram illustrating an example of a processing module in source code included in DNN processing.

FIG. 5 is an explanatory diagram illustrating an example of a path node dictionary.

FIG. 6 is a flowchart illustrating the remaining part of the AT part specifying processing routine.

FIG. 7 is a flowchart illustrating a merge confirmation processing flow.

FIG. 8 is an explanatory diagram illustrating an example of an AT part check dictionary.

FIG. 9 is a flowchart illustrating a AT part confirmation sub-flow.

FIG. 10 is an explanatory diagram illustrating an example of an AT part dictionary.

FIG. 11 is an explanatory diagram exemplifying the correspondence between each node of the processing module and the AT part dictionary.

FIG. 12A is an explanatory diagram illustrating the number of memory accesses by a single core.

FIG. 12B is an explanatory diagram illustrating the number of memory accesses by multiple cores.

### DESCRIPTION OF EMBODIMENTS

To being with, examples of relevant techniques will be described.

In deep learning neural networks (hereinafter referred to as DNN), typified by transformers, the computational load and number of parameters are large, resulting in lengthy processing times. Therefore, multicore processors are sometimes used to distribute processing across multiple cores in order to achieve higher processing speeds. In such cases, if all processing is simply performed using multicore processors, there may be instances where parallelized processes interfere with each other, and the acceleration provided by multicore processing may not be sufficiently achieved. Thus, for example, when parallelization causes interference among the processing of multiple cores, it has been proposed to perform the processing using a single core instead of multicore processing.

However, even when processing is assigned to multiple cores and little to no interference occurs due to parallelization, there are cases where acceleration cannot be achieved depending on the processing of the DNN.

The present disclosure can be implemented in the following embodiments or applications.
(1) The present disclosure can be implemented as a compiler targeting a multi-core processor. The compiler includes a determination unit configured to perform determination whether to have the multi-core processor including multiple cores perform multi-core processing or single core processing, and a convert unit configured to convert a source code into an object code that is executable by the multi-core processor according to the determination by the determination unit. The multi-core processing is processing of executing a source code with the multiple cores. The single-core processing is processing of executing the source code with one of the multiple cores. The determination unit is further configured to determine the single-core processing as at least one of, in the source code: (i) a first process of performing probability calculation; or (ii) a second process including a branch node at which a process is branched into sub-processes, a merge node at which the sub-processes merge, and at least one of a tensor transpose node or an inner product calculation node between the branch node and the merge node. The tensor transpose node is configured to transpose a tensor. The inner product calculation node is configured to perform inner product calculation.
(2) The present disclosure can also be implemented as a compilation method. The compilation method is a method for converting a source code for a multi-core processor including multiple cores into an object code that is executable by the multiple-core processor. The compilation method includes determining having the multi-core processor perform a single-core processing of executing the source code with one of the multiple cores for at least one of, in the source code: (i) a first process of calculating probability; or (ii) a second process including a branch node at which a process is branched into sub-processes, a merge node at which the sub-processes merge, and at least one of a tensor transpose node or an inner product calculation node between the branch node and the merge node. The tensor transpose node is configured to transpose a tensor. The inner product calculation node is configured to perform an inner product calculation. The method includes determining having the multi-core processor perform a multiple-core processing of executing the source code with the multiple cores for a process other than the first process and the second process, and converting the source code into the object code according to a result of the determining.

In any of the above configurations, it is possible to avoid or reduce generated object code that increases the number of times computation data must be read due to multi-core processing. When the number of times computation data is read does not increase, the time required for reading out the computation data does not increase. Thus, it is possible to avoid or reduce situations in which the overall processing time actually increases as a result of uniformly adopting multi-core processing.

### A. First Embodiment

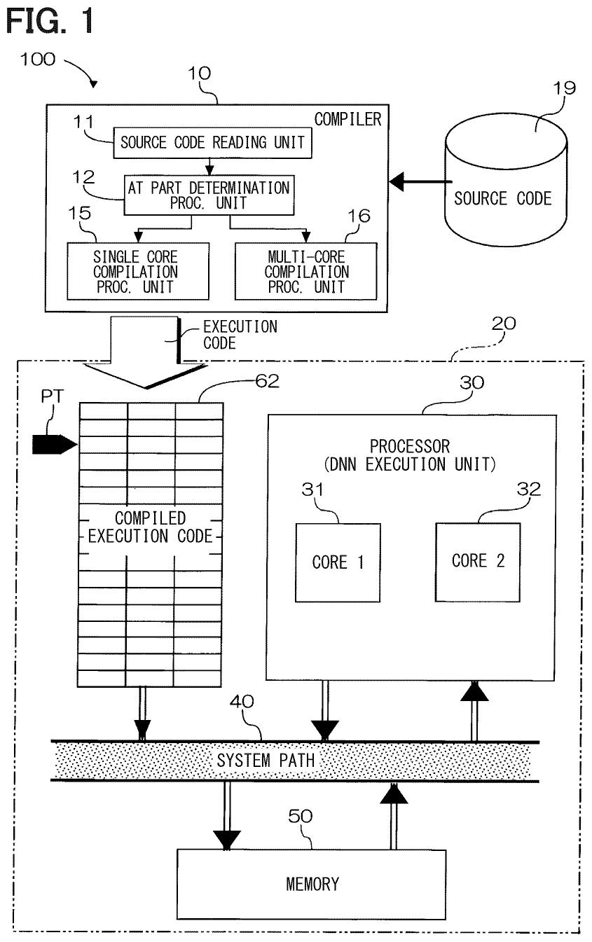

(A1) System Overview: FIG. 1 is a schematic configuration diagram illustrating a processing system 100, which includes a compiler 10 according to a first embodiment and an execution machine 20 that executes executable code generated by the compiler 10. As illustrated, the execution machine 20 reads source code stored in a storage device 19, such as a hard disk or SSD, compiles the source code to generate executable code. The source code compiled by the compiler 10 of the present embodiment is primarily code related to execution of DNN (Deep Learning Neural Network). The compiler 10 includes a source code reading unit 11 configured to sequentially read the source code from the storage device 19, an AT part determination processing unit 12 configured to analyze the source code and determine whether an attention part (hereinafter referred to as “AT part”) is present in the source code, and a single-core compilation processing unit 15 for compiling for single-core operation and a multi-core compilation processing unit 16 for compiling for multi-core operation in accordance with the determination by the AT part determination processing unit 12. The details of the operations of each unit will be described in detail later using flowcharts.

The executable code generated by compilation with the compiler 10 is transferred to the execution machine 20, which actually executes this executable code. The transfer may be performed via a network, or the compiled executable code may be transferred using a memory medium or the like. The executable code is code that is stored on the execution machine 20 and can be directly executed by a processor 30 of the execution machine 20. The executable code includes an instruction code (opcode) specifying a process and an operand indicating a target of the process. The executable code is stored in a predetermined stack 62. The executable code is read out by the processor 30 via a system bus 40 from a location indicated by a pointer PT.

In the present embodiment, the processor 30 includes two cores 31 and 32. When the executable code is compiled to be executed on a single core, the executable code is processed by the first core 31. When the executable code is compiled to be executed on multiple cores, the executable code is processed in parallel by the first core 31 and the second core 32. In the present embodiment, the first core 31 and the second core 32 are provided as multiple cores of the processor 30. However, it is also possible to compile the source code for the executable code to be executed by a multi-core processor including an even greater number of cores, such as four cores, eight cores, . . . thirty-two cores, and so on.

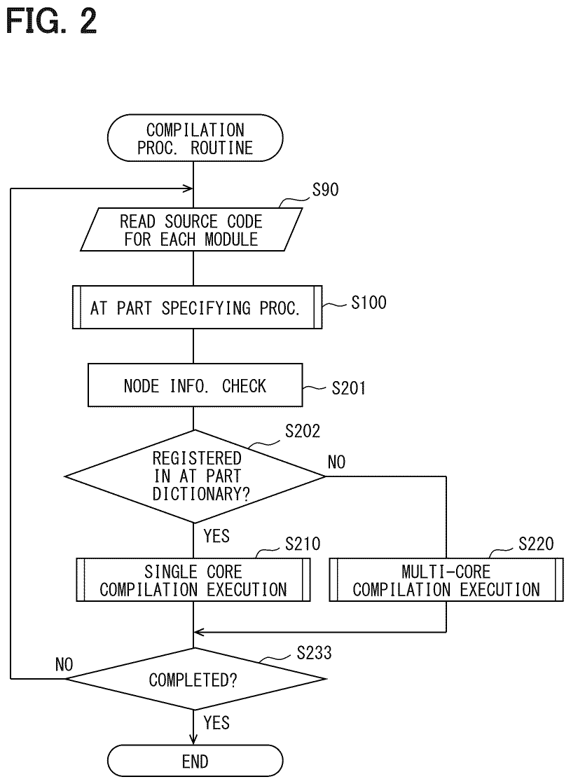

The operand of the executable code may directly specify the data to be processed, but generally specifies the address in the memory 50 where the data to be processed is stored. In this case, the processor 30 reads the data to be processed from the memory 50. Additionally, in some cases, the processed data may be written to a predetermined address in the memory 50. The speed of data processing is affected not only by the processing speed of the first core 31 and the second core 32 in the processor 30, but also by the access speed and the number of accesses to the memory 50. The processing speed of executable code by the processor 30 will be explained in detail later.
(A2) Compiler Processing: Next, the processing performed when compiling the source code read from the storage device 19 will be described. FIG. 2 is a flowchart showing an example of a compilation processing routine executed by the compiler 10. When this processing starts, the source code reading unit 11 reads the source code from the storage device 19 (step S90). The reading of the source code is performed for each module that constitutes the entire source code.

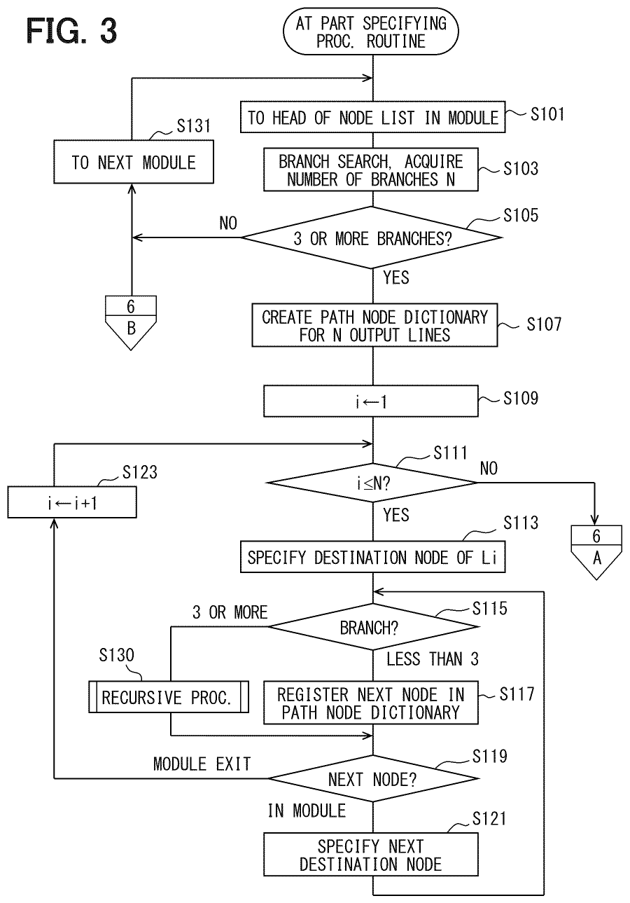

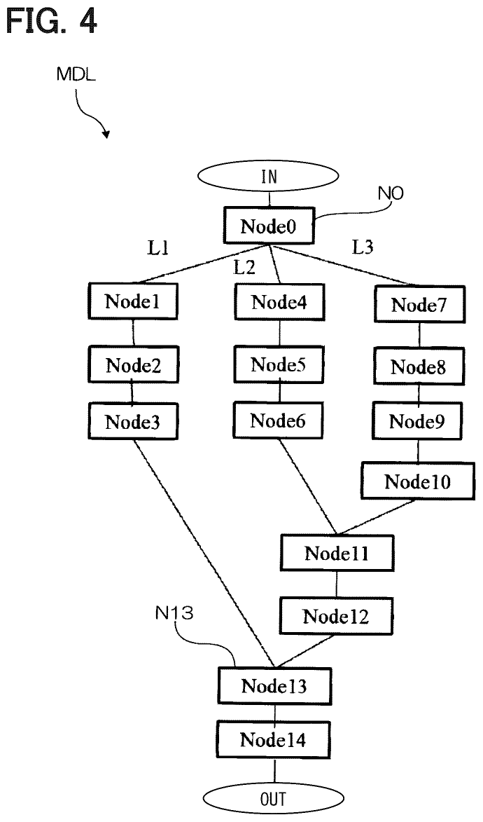

After reading the source code by module, AT part specifying processing (step S100), which specify an AT part is executed by the AT part determination processing unit 12. The details of the AT part specifying processing (step S100) will be described with reference to FIG. 3. The AT part specifying processing (step S100) consists of a flow for checking whether there are three or more branches and whether the branches merge, and a flow for confirming whether nodes between the branch and the merge meet predetermined conditions. FIG. 4 shows an example of a processing module targeted by the AT part identifying processing. The processing illustrated is one of the processing modules within the source code included in DNN processing.

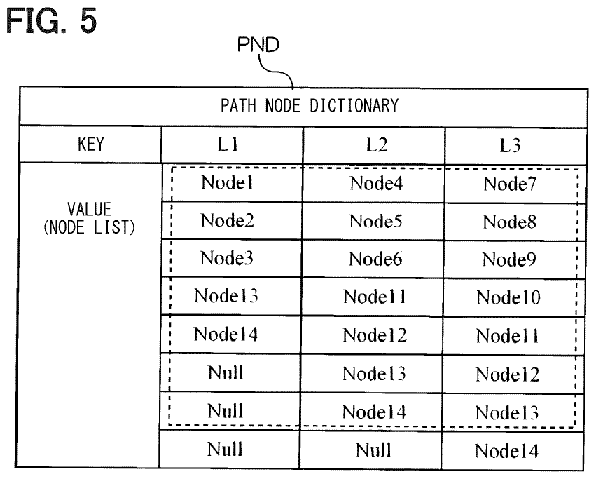

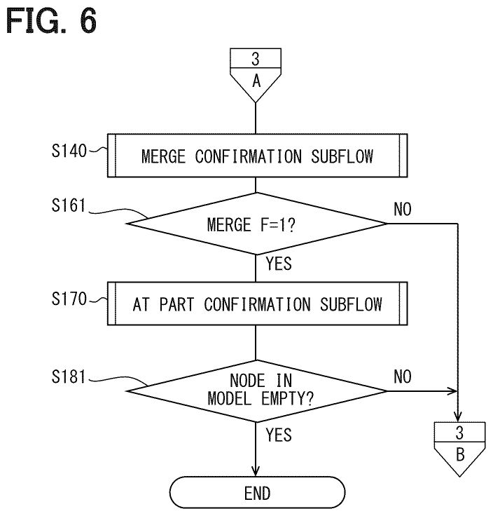

In the AT part specifying processing, a path node dictionary is created as described below. The path node dictionary manages each branching route (for example, lines L1 to L3) as keys for the path node dictionary, and multiple nodes as values. An example of the path node dictionary is shown in FIG. 5. The details of the AT part specifying processing will be described below with reference to the flowchart (FIG. 3), the example of the processing module (FIG. 4), and the path node dictionary (FIG. 5). The remaining part of the AT part specifying processing is shown in FIG. 6, and this remaining part will also be explained later.

As shown in FIG. 3, when the AT part specifying processing routine starts, searching of branch is started from the head of a node list within the module (step S101), and when a branch is found, the number of branches N is acquired (step S103). Subsequently, it is determined whether there is three or more branches (step S105), and when even a single branch point with three or more branches (N≥3) is found (step S103: “YES”), steps S107 and subsequent steps are executed. When no branch point with three or more branches is found within the module (step S105: “NO”), it is determined that there is no AT part in this module, the processing moves to the next module (step S131), and repeats the above processing from step S101.

In the example shown in FIG. 4, Node 0 indicated by reference numeral NO has three branches, so it is determined that the processing module has N branches where N is three or more (step S105: “YES”), and a path node dictionary PND for N output lines is created (step S107). At this stage, only the dictionary has been created and its contents are still empty (Null). Next, a variable i, which indicates the number of lines, is initialized to the value 1 (step S109), and it is determined whether this variable i is less than or equal to N (step S111). When the determination in step S111 is “YES,” that is, when the identification number of a line to be processed is less than or equal to the number of detected branches, the destination node connected to the line Li is specified (step S113).

Immediately after the process starts, the variable i has the value 1, so the destination node of line L1, that is, Node 1 in FIG. 4, is specified, and, when the line L1 has a branch point, it is further determined whether the number of branches is three or more (step S115). When the number of branches is less than three, the destination node (in this case, Node 1) is registered in the path node dictionary PND (step S117), and it is then determined whether the next node corresponds to the exit of the processing module (step S119). When it is not the exit of the processing module, the process returns to step S115 and the above processing is repeated (steps S115 to S119). As a result, the nodes existing on the line L1 are successively found as the next node and registered in the path node dictionary PND (step S117). Once up to Node 3 on the line L1 has been found and registered in the path node dictionary PND, the subsequent destination nodes 13 and 14 are identified and registered in the path node dictionary PND.

The above processing for the line L1 (steps S115 to S119) is repeated, and once registration up to Node 14 is completed, in step S119, it is determined that “the next node is the exit of the processing module.” Thus, the variable i, which indicates the line to be processed, is incremented by 1 (step S123), and the above processing is repeated from step S111. In other words, the lines L2 and L3 are sequentially processed after the line L1. As a result, in the processing module shown in FIG. 4, Nodes 4 to 6 and 11 to 14 are registered in the path node dictionary PND for the line L2, and Nodes 7 to 14 are registered for the line L3, respectively (see FIG. 5). Once the processing for all lines (here, L1 to L3) has been completed in this way, the determination in step S111 is “NO,” and the process proceeds to the remaining part of the AT part specifying processing shown in FIG. 6. When a branch of three or more is found (step S105: Yes) and, during the execution of the processing after step S111, another branch of three or more is found (step S115: three or more), the processing shown in FIG. 3 is recursively executed. In other words, the processing module includes a section that may be determined as an AT part. Thus, a new path node dictionary PND is generated, and nodes are registered. Since this processing is similar to the above-described processing, a detailed description is omitted.

When it is determined that the search for nodes and the registration in the path node dictionary PND for all lines included in the processing module has been completed (step S111: NO), the process proceeds to FIG. 6. The pentagonal symbols in the figures indicate, at the top, the number of the figure to which the connection is made, and at the bottom, the terminal code in the figure. Accordingly, when the determination in step S111 is NO, processing continues from the terminal marked “A” in FIG. 6.

The processing shown in FIG. 6 corresponds to the remaining portion of the AT part identifying process depicted in FIG. 3. First, the overall flow of the process will be explained, followed by a description of the contents of each sub-flow. After creating the path node dictionary PND as shown in FIG. 3, a merge confirmation sub-flow (step S140) is executed. In the merge confirmation sub-flow, a determination is made regarding the value of a flag F, which reflects the result of whether the branches of the target processing module have merged or not (step S161). When it is not determined that flag F=1 (step S161: NO), the process returns to terminal B in FIG. 3 and continues the processing shown in FIG. 3. On the other hand, when it is determined that flag F=1 (step S161: YES), the AT part confirmation sub-flow (step S170) is executed. Thereafter, when there are still unprocessed nodes, that is, unprocessed modules, in the processing model (step S181: NO), the process returns to terminal B in FIG. 3 and continues processing. When there are no unprocessed nodes in the target model (step S181: YES), the process exits to “END” and ends the AT part specifying processing (FIG. 3 and FIG. 6).

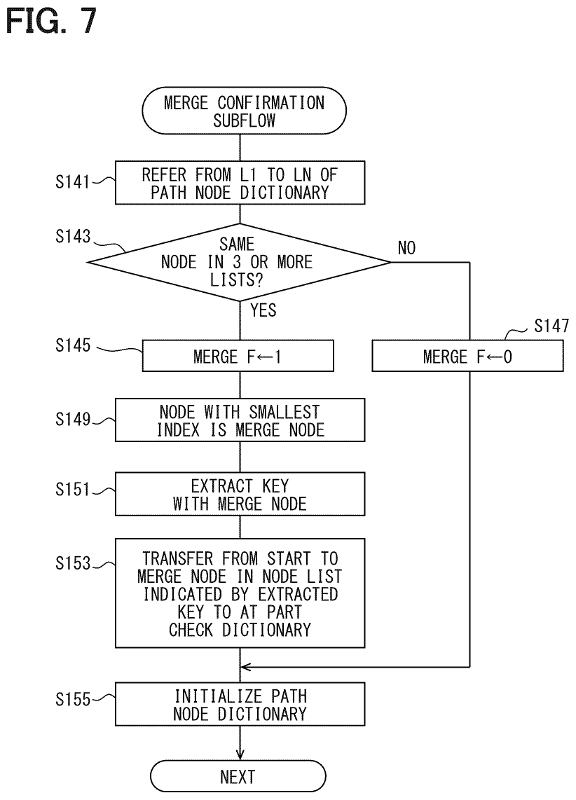

The merge confirmation sub-flow (step S140) and the AT part confirmation sub-flow (step S170) shown in FIG. 6 will be explained in detail. FIG. 7 is a flowchart showing the details of the merge confirmation sub-flow. As illustrated, in the merge confirmation sub-flow, all nodes from the line L1 to LN registered in the path node dictionary PND are referenced (step S141), and it is determined whether there is any identical node present in at least three or more of the lines from the L1 to LN (step S143). In the example shown in FIG. 5, the same node 13 exists as the fourth node of the line L1, the seventh node of the line L2, and the eighth node of the line L3. In this case, the determination in step S143 is YES, and it is determined that three or more lines merge at node 13, indicated as reference sign N13 in FIG. 4, and the merge flag F is set to a value of 1 (step S145). On the other hand, when there is no identical node in at least three lines (step S143: NO), the merge flag F is set to a value of 0 (step S147). In this case, it is determined that in the target processing module, three or more lines do not merge with each other, and the path node dictionary PND is initialized (step S155). After step S155, this sub-flow exits to “NEXT” and ends.

When it is determined “YES” in step S143, the node with the smallest number (index) is set as a merge node (step S149). When there are other identical nodes in three or more lines, the node with the smallest index is set as the merge node. Next, keys including the merge node are extracted (step S151), and the nodes from the beginning of the node list indicated by the extracted keys up to the merge node are copied into the AT part check dictionary ACD (step S153).

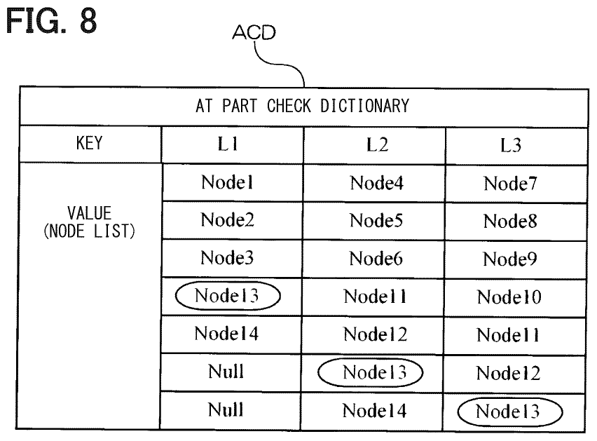

An example of the AT part check dictionary is shown in FIG. 8. As illustrated, the Node 13, enclosed by an oval, is commonly present in the lines L1 through L3. Accordingly, the portion from the node following the branch start Node 0 up to the common node 13, that is, the enclosed portion of the path node dictionary PND with the dashed line, is copied. The reason for extracting keys with the merge nodes is that, in the case of branching into four or more lines, it is not necessary for identical node to be present in all lines. It is sufficient if the identical node exist in at least three lines. After the above processing, the path node dictionary PND is initialized (step S155), and the merge confirmation sub-flow is ended.

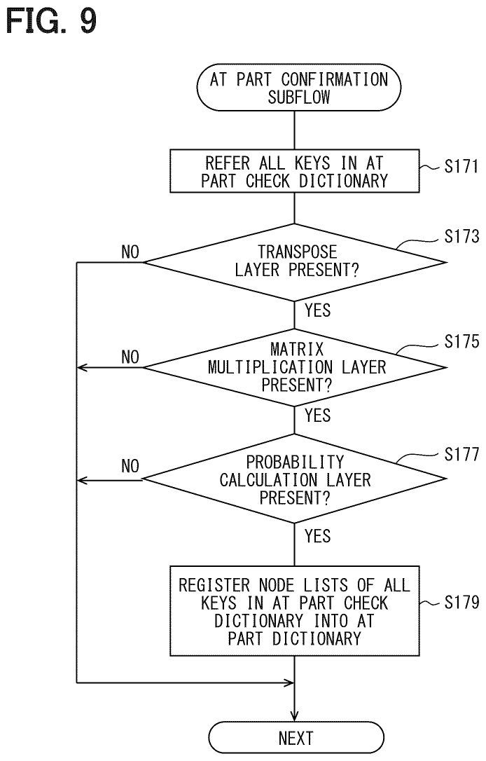

The merge confirmation sub-flow described above sets the merge flag F to either value 1 (merge present) or value 0 (no merge). Accordingly, when the merge flag F has the value 1, the AT part confirmation sub-flow is executed. An example of the AT part confirmation sub-flow is shown in FIG. 9. In this AT part confirmation sub-flow, all the keys of the AT part check dictionary ACD, which have been copied, are first referenced (step S171). Then, for all nodes present in the AT part check dictionary ACD, the following three checks are performed (steps S173, S175, and S177).
[1] Whether there is a transpose layer that performs the transposition of a matrix (Transpose) among the nodes in the AT part check dictionary ACD (step S173); [2] whether there is an inner product layer that performs the inner product of vectors (MatMul) among the nodes in the AT part check dictionary ACD (step S175); and [3] whether there is a layer that performs probability calculation, specifically a SoftMax operation, among the nodes in the AT part check dictionary ACD (step S177).

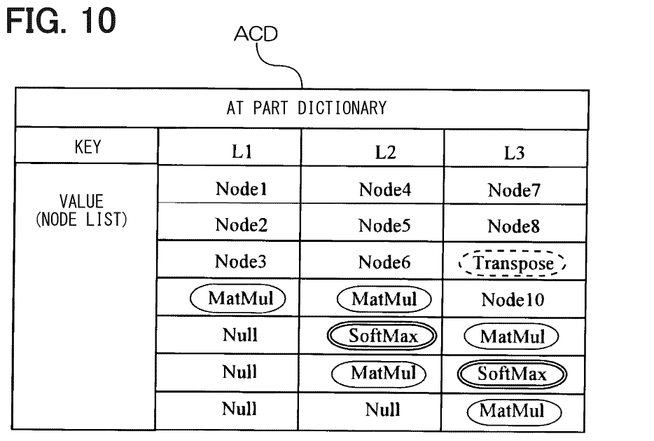

After performing the above checks, when the result of any one of the judgments [1], [2], or [3] is “NO,” no further action is taken, and the process exits to “NEXT,” thereby ending the processing of the AT part confirmation sub-flow. On the other hand, when all of the judgments [1], [2], and [3] are “YES,” it is determined that this processing module is an attention part, and the node list of all keys in the AT part check dictionary ACD is registered in the AT part dictionary ATD (step S179). An example of the AT part dictionary ATD is shown in FIG. 10. The nodes enclosed by dashed ellipses are nodes that perform transposition, the nodes enclosed by solid ellipses are nodes that perform inner product operations, and the nodes enclosed by double solid ellipses are nodes that perform probability calculations.

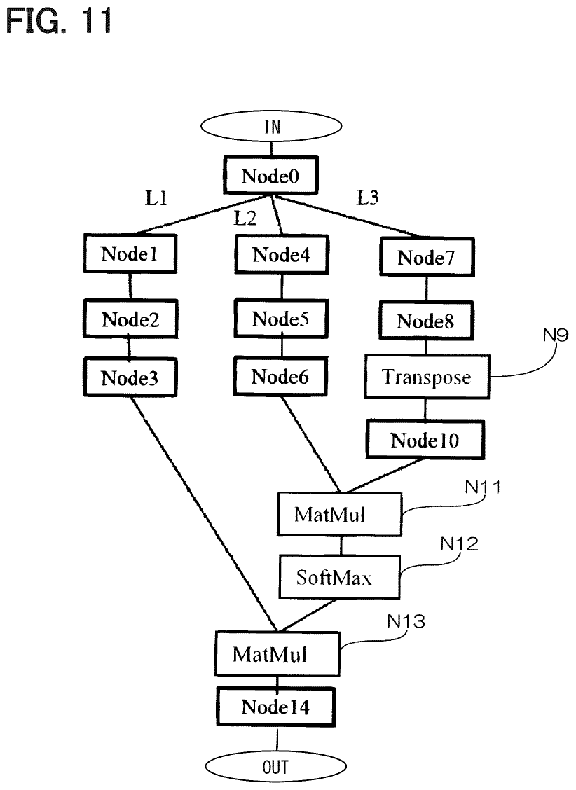

With the above, the AT part specifying process (step S100) shown in FIG. 2 is completed. Upon completion of the above AT part specifying process shown as step S100, the compiler refers to the AT part dictionary ATD created during the AT part specifying processing to check node information (step S201). When it is determined whether nodes satisfying the above-mentioned conditions [1], [2], and [3] are registered in the AT part dictionary ATD (step S202), and when it is determined that the nodes are registered (step S202: Yes), single-core compilation is executed for the loaded module (step S210). On the other hand, when it is determined the nodes are not registered (step S202: No), multi-core compilation is executed (step S220). As a result of the determination of the above-mentioned [1], [2], and [3], it has been found that the processing module exemplified in FIG. 4 includes, as shown in FIG. 11, a transposition process in node N9, inner product operations in nodes N11 and N13, and a probability calculation in node N12. Thus, this processing module is considered to be the AT part (Attention part) in DNN processing, and single-core compilation will be performed for the processing module. The compilation may be performed immediately after the determination for each processing module. However, it is also possible to mark each processing module as to whether the single-core compilation or the multi-core compilation should be applied, and then later compile them all at once with the respective compilers.

After the above processing, it is determined whether the processing for all processing modules included in the source code has been completed (step S233). The processing from step S90 to step S233 described above is repeated until the processing for all processing modules is completed. When the processing for all processing modules has been completed, the compilation processing routine proceeds to “END” and ends.

The compiler 10 described above can perform compilation targeting a multi-core processor. The compiler 10 accurately specifies the attention part of a transformer-type DNN, compile the source code of the attention part for single-core processing by one of the cores included in the multi-core processor, and convert the source code of the attention part into executable object code. The attention part is detected, as described above, based on the following conditions: the processing module includes a branch point with three or more branches; at least three of the branched lines are merged; multiple nodes exist between the branch and the merge and there are a layer that performs transposition processing, a layer that performs inner product operations, and a layer that performs probability calculations. With these conditions, the attention part can be reliably detected. Thus, for example, processing with only two branches, or processing that branches into three or more paths but transitions to other processing modules without merging, will not be recognized as an attention part.

In the above embodiment, only the attention part is compiled for single-core processing. However, when a processing module performs probability calculations, it is also possible to similarly compile the processing module for single-core processing. Alternatively, it is also possible to perform compilation for single-core processing when there are three or more branches within the processing module, at least three of the branched lines are merged, and at least one of a node that transposes tensors or a node that performs inner product operations is included between the branch and the merge (the node N13).

By doing so, the object code executed by the processor 30 of the execution machine 20 after compilation will have fewer accesses to the memory 50, and thus will be less susceptible to the impact of the speed for accessing to the memory 50, compared to when parallel processing using multiple cores is performed. As a result, the execution speed can be increased.

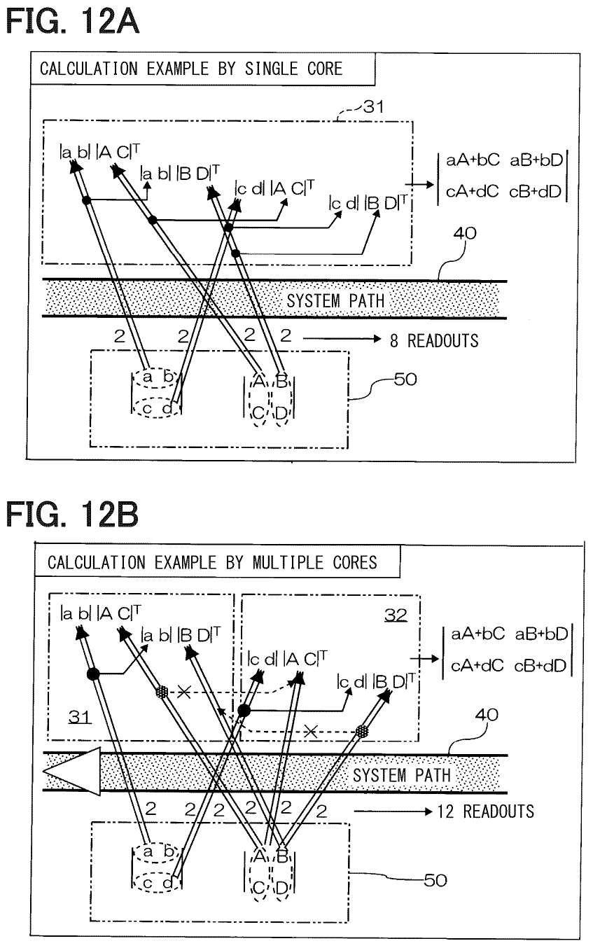

This point will be explained with reference to FIGS. 12A and 12B. FIGS. 12A and 12B are explanatory diagrams showing the number of memory accesses in the case of calculation to obtain an inner product M of two 2×2 matrices. In this example, the following equation (1) is assumed as an example of an inner product operation of matrices. The symbol “.” in the equation indicates the inner product operation. Also, the symbol “T” attached to the upper right of [A C], as in [A C]^{T}, indicates that [A C] is a transposed matrix.

$$M = \vert \begin{matrix}a & b \\ c & d\end{matrix} \vert \cdot \vert \begin{matrix}A & B \\ C & D\end{matrix} \vert = \vert \begin{matrix}aA + bC & aB + bD \\ cA + dC & cB + dD\end{matrix} \vert \qquad ( 1 )$$

FIG. 12A shows the case in which this inner product calculation is performed using one of the two cores built into the processor 30, namely, the first core 31. When performing the inner product calculation of the equation (1), four operations given by equations (2) to (5) are carried out. Here, M (i, j) denotes the element in the i-th row and j-th column of the matrix M, which represents the inner product.

[a b][A C]^{T}=aA+bC (2)

M(1,2)=[a b][B D]^{T}=aB+bD (3)

M(2,1)=[c d][A C]^{T}=cA+dC (4)

M(2,2)=[c d][B D]^{T}=cB+dD (5)

In this case, since the first core 31 uses the data [a b] and [A C]^{T} for the calculation in the equation (2), it performs a total of four data read operations from the memory 50 via the system bus 40. For the calculation in the equation (3), since the data [a b] has already been read, the only additional data required is [B D]^{T}, so data is read from the memory 50 via the system bus 40 two times. For the calculation in the equation (4), since the data [A C] has already been read, the only additional data required is [c d]^{T}, so data is read from the memory 50 via the system bus 40 two times. The data required for the calculation in the equation (5) has already been read during the calculations for the equations (3) and (4), so in this case, no data is read from the memory 50 via the system bus 40. As a result, only eight data read operations from the memory 50 via the system bus 40 are required.

In contrast, when performing similar inner product operations using the multicore configuration with the first core 31 and the second core 32 built into the processor 30, a total of twelve data read operations from the memory 50 via the system bus 40 are required. This situation is illustrated in FIG. 12B. In multi-core processing, the inner product calculation is performed in parallel by the two cores 31 and 32. As illustrated, in this example, the first core 31 performs the calculations of the above equations (2) and (3), while the second core 32 performs the calculations of the above equations (4) and (5). In computations using multiple cores, as indicated by the “x” marks in FIG. 12B, each of the first core 31 and the second core 32 cannot utilize the data used in calculations by the other core. Thus, each core needs to perform six data read operations from the memory 50 via the system bus 40. Thus, when processing with multiple cores, the total number of accesses to the memory 50 required to perform the same inner product calculation becomes twelve. Accordingly, processing with multiple cores results in the number of memory accesses (read operations) to the memory 50 via the system bus 40 being 1.5 times higher, which means that, in spite of the advantages of parallel processing, there is the significant disadvantage of increased time required for data retrieval. Such an increase in the number of memory accesses does not particularly occur in operations such as matrix addition. For example, in the case of adding two 2×2 matrices, it is necessary to read out four data elements in both single-core and multi-core processing. Thus, a total of eight data read operations from the memory 50 via the system bus 40 are required, and there is no difference in this regard between the single core and multi-core processing.

### B. Other Embodiments

(1) One other embodiment is a compiler targeting multi-core processors. The compiler includes a determination unit configured to perform determination whether to have the multi-core processor including multiple cores perform multi-core processing or single core processing, and a convert unit configured to convert a source code into an object code that is executable by the multi-core processor according to the determination by the determination unit. The multi-core processing is processing of executing a source code with the multiple cores. The single-core processing is processing of executing the source code with one of the multiple cores. The determination unit may be further configured to determine the single-core processing as at least one of, in the source code: (i) a first process of performing probability calculation; or (ii) a second process including a branch node at which a process is branched into sub-processes, a merge node at which the sub-processes merge, and at least one of a tensor transpose node or an inner product calculation node between the branch node and the merge node. The tensor transpose node is configured to transpose a tensor. The inner product calculation node is configured to perform inner product calculation. In this way, it is possible to avoid or reduce generated object code that increases the number of times computation data must be read due to multi-core processing. When the number of times computation data is read does not increase, the time required for reading out the computation data does not increase. Thus, it is possible to avoid or reduce situations in which the overall processing time actually increases as a result of uniformly adopting multi-core processing.

The at least two conditions under which the compiler selects single-core compilation includes [1] the first processing that performs probability calculations. The first processing may be included in the output layer of a DNN model, where it may be necessary to compute the probability for each of a large number of outputs. Such probability calculations repeatedly use a large amount of data from the preceding stages of the DNN model, so processing with multiple cores may highly likely result in an increased number of data read operations compared to the processing with a single core. With the compiler of the above configuration, it is possible to reduce the potential increase in processing time that may result from the increased number of data read operations. In addition, regarding [2] the second processing including nodes, which includes a branch node at which a process is branched into sub-processes, a merge node at which the sub-processes merge, and at least one of a tensor transpose node or an inner product calculation node between the branch node and the merge node, the same data is used multiple times for the transposition of tensors and the inner product calculation. Thus, compilation of such processing to be executed by a single core decreases the potential increase in processing time that may result from the increased number of data read operations. Note that the tensor transpose node is configured to transpose a tensor, and the inner product calculation node is configured to perform inner product calculation.
(2) In the above configuration, the source code may be code that implements at least a part of a deep learning neural network (DNN) model. This is because, DNN models requires processing that involves referencing data multiple times such as probability calculations, tensor transpositions, and inner product operations. It should be noted that such source code is not limited by the type of programming language described above.
(3) In the configuration described in (1) and (2) above, the second processing may be processing included in the attention part used in transformer-type models. In this way, it is possible to suppress an increase in the number of times data is read during operations in the attention part, where probability calculations and similar processing are executed, thereby avoiding or reducing a decrease in processing speed.
(4) In the above configuration, the determination unit may determine that the section including the branch node, the merge node, and at least tensor transposition, an inner product operation using the transposed tensor, and a probability calculation between the branch node and the merge node is an attention part. In this way, it is possible to reliably and easily determine whether the section is an attention part.
(5) In the above configuration, the branch node may have three or more branches, the transposed tensor may be a tensor calculated in a deep learning network, and the inner product operation may be an inner product operation between the transposed tensor and a non-transposed tensor. In this way, the determination of whether the section is an attention part can be made even more reliably.
(6) The present disclosure can be implemented as a compilation method. The compilation method is a method for converting a source code for a multi-core processor including multiple cores into an object code that is executable by the multiple-core processor. The compilation method includes determining having the multi-core processor perform a single-core processing of executing the source code with one of the multiple cores for at least one of, in the source code: (i) a first process of calculating probability; or (ii) a second process including a branch node at which a process is branched into sub-processes, a merge node at which the sub-processes merge, and at least one of a tensor transpose node or an inner product calculation node between the branch node and the merge node. The tensor transpose node is configured to transpose a tensor. The inner product calculation node is configured to perform an inner product calculation. The method includes determining having the multi-core processor perform a multiple-core processing of executing the source code with the multiple cores for a process other than the first process and the second process, and converting the source code into the object code according to a result of the determining. In this way, it is possible to avoid or reduce generated object code that increases the number of times computation data must be read due to multi-core processing. When the number of times computation data is read does not increase, the time required for reading out the computation data does not increase. Thus, it is possible to avoid or reduce situations in which the overall processing time actually increases as a result of uniformly adopting multi-core processing.
(7) In each of the above embodiments, a part of the configuration that has been implemented by hardware may be replaced with software. At least a part of the configuration that has been implemented by software may also be implemented by a discrete circuit configuration. Further, when some or all of the functions of the present disclosure are implemented by software, the software (computer program) can be provided in a form stored on a computer-readable storage medium. The term “computer-readable storage medium” is not limited to portable recording media such as flexible disks or CD-ROMs, but also includes various internal storage devices within a computer, such as RAM and ROM, as well as external storage devices fixed to the computer, such as hard disks. That is, the term “computer-readable storage medium” has a broad meaning and includes any recording medium capable of storing data packets in a non-temporary, fixed manner.

The present disclosure is not limited to the embodiments described above, and may be implemented in various configurations without departing from the spirit thereof. For example, the technical features in the embodiments corresponding to the technical features described in each form in the summary of the invention may be appropriately substituted or combined in order to solve some or all of the aforementioned problems or to achieve some or all of the aforementioned effects. In addition, unless a technical feature is described in this specification as being essential, it may be appropriately omitted.

1. A non-transitory computer readable storage medium storing a compiler program, when executed by at least one processor, cause the at least one processor to perform:
determining whether to have a multi-core processor including multiple cores perform multi-core processing or single-core processing, the multi-core processing being processing of executing a source code with the multiple cores, the single-core processing being processing of executing the source code with one of the multiple cores; and
converting the source code into an object code that is executable by the multi-core processor according to a result of the determining, wherein
the determining of whether to have the multi-core processor perform the multi-core processing or the single-core processing includes determining the single-core processing as at least one of, in the source code:
(i) a first process of performing probability calculation; or
(ii) a second process including a branch node at which a process is branched into sub-processes, a merge node at which the sub-processes merge, and at least one of a tensor transpose node or an inner product calculation node between the branch node and the merge node, the tensor transpose node being configured to transpose a tensor, the inner product calculation node being configured to perform inner product calculation.

2. The non-transitory computer readable storage medium according to claim 1, wherein
the source code implements at least a part of a deep learning neural network model.

3. The non-transitory computer readable storage medium according to claim 2, wherein
the second process is included in an attention part that is used in a transformer-based model.

4. The non-transitory computer readable storage medium according to claim 3, wherein
the determining of whether to have the multi-core processor perform the multi-core processing or the single-core processing includes identifying, as the attention part, a part that includes at least a tensor transpose, an inner product calculation and the probability calculation using the transposed tensor between the branch node and the merge node.

5. The non-transitory computer readable storage medium according to claim 4, wherein
the sub-processes are at least three processes,
the transposed tensor is a tensor calculated with a deep learning network, and
the inner product calculation is an inner product calculation between the transposed tensor and a tensor that is not transposed.

6. A compilation method for converting a source code for a multi-core processor including multiple cores into an object code that is executable by the multi-core processor, the compilation method comprising:
determining having the multi-core processor perform a single-core processing of executing the source code with one of the multiple cores for at least one of, in the source code:
(i) a first process of calculating probability; or
(ii) a second process including a branch node at which a process is branched into sub-processes, a merge node at which the sub-processes merge, and at least one of a tensor transpose node or an inner product calculation node between the branch node and the merge node, the tensor transpose node being configured to transpose a tensor, the inner product calculation node being configured to perform an inner product calculation;
determining having the multi-core processor perform a multiple-core processing of executing the source code with the multiple cores for a process other than the first process and the second process; and
converting the source code into the object code according to a result of the determining.

7. An execution machine comprising at least one processor and a memory storing a compiler program, when executed by the at least one processor, cause the execution machine to perform:
determining whether to have a multi-core processor including multiple cores perform multi-core processing or single-core processing, the multi-core processing being processing of executing a source code with the multiple cores, the single-core processing being processing of executing the source code with one of the multiple cores; and
converting the source code into an object code that is executable by the multi-core processor according to a result of the determining, wherein
the determining of whether to have the multi-core processor perform the multi-core processing or the single-core processing includes determining the single-core processing as at least one of, in the source code:
(i) a first process of performing probability calculation; or
(ii) a second process including a branch node at which a process is branched into sub-processes, a merge node at which the sub-processes merge, and at least one of a tensor transpose node or an inner product calculation node between the branch node and the merge node, the tensor transpose node being configured to transpose a tensor, the inner product calculation node being configured to perform inner product calculation.

8. The execution machine according to claim 7, wherein
the at least one processor is the multi-core processor.
